(19) United States
(12) Patent Application Publication
(10) Pub. No.: US 2011/0024243 A1
(43) Pub. Date: Feb. 3, 2011

(54) ELECTRONIC PARKING BRAKE SYSTEM AND CONTROL METHOD THEREOF

(75) Inventor: Wook Jin Choi, Seoul (KR)

Correspondence Address: MCDERMOTT WILL & EMERY LLP, 600 13TH STREET, N.W., WASHINGTON, DC, 20005-3096, US

(73) Assignee: MANDO CORPORATION

(21) Appl. No.: 12/846,367

(22) Filed: Jul. 29, 2010

(30) Foreign Application Priority Data
Jul. 29, 2009 (KR) 10-2009-69421

(51) Int. Cl. F16D 65/14; B60T 11/04; G06F 19/00

(52) U.S. Cl. 188/158; 701/70

(57) ABSTRACT

Disclosed herein are an electronic parking brake system and a control method thereof. The electronic parking brake system includes brakes, a parking cable to apply braking force to the brakes, a motor to apply tension to the parking cable, a current sensor to sense current of the motor, and an electronic control unit to judge the braking force of the brakes based on the current of the motor, and to control driving of the motor based on the braking force. The electronic parking brake system senses the tension of the parking cable using the small-sized current sensor, thereby easily obtaining a space in which the current sensor is installed and thus reducing a product size of the electronic parking brake system. Further, the electronic parking brake system senses the tension of the parking cable using the inexpensive current sensor, thereby reducing manufacturing costs of the electronic parking brake system and reducing costs of an electronic parking brake system product and a vehicle provided with the same.

### CROSS-REFERENCE TO RELATED APPLICATION

This application claims the benefit of Korean Patent Application No. 2009-0069421, filed on Jul. 29, 2009 in the Korean Intellectual Property Office, the disclosure of which is incorporated herein by reference.

### BACKGROUND

1. Field

Embodiments of the present invention relate to an electronic parking brake system which ensures braking force of a cable puller type parking brake apparatus, and a control method thereof.

2. Description of the Related Art

In general, a brake system is a system which decelerates and stops a vehicle during driving and simultaneously maintains the stopped state of the vehicle. The brake system includes a parking brake apparatus which decelerates and stops a vehicle during driving and simultaneously maintains the stopped state of the vehicle.

The parking brake apparatus is configured such that, when a lever provided at one side of a driver's seat in a vehicle is operated, a parking cable is pulled and then provides braking force to vehicle wheels connected to the parking cable to maintain a stopped state of the vehicle wheels, and, when the lever is released, the parking cable is loosened to release the braking force from the vehicle wheels. Such an operating type of the parking brake apparatus to supply braking force to the vehicle wheels or release the braking force from the vehicle wheels using tension of the parking cable is referred to as a cable puller type.

As to such a cable puller type parking brake apparatus, a driver has to operate the lever whenever the parking brake apparatus is operated, i.e. parking or driving of the vehicle is started, only by driver's intention, and thus use of the parking brake apparatus is very cumbersome. Therefore, an electronic parking brake (EPB) system which enables a parking brake apparatus to be automatically operated by a motor according to an operating state of a vehicle has been developed.

The electronic parking brake (EPB) system operates the parking brake apparatus or stops the operation of the parking brake apparatus and ensures stability in braking in case of emergency in connection with a manual operation mode, a hydraulic electronic control unit (HECU), an engine electronic control unit (ECU), and a traction control unit (TCU) through switch operation.

The above electronic parking brake (EPB) system includes an electronic control unit (ECU), a motor, a gear, a parking cable, and a force sensor, which are integrally formed. Here, the electronic control unit (ECU) receives related data input from the hydraulic electronic control unit (HECU), the engine electronic control unit (ECU), and the traction control unit (TCU) through controller area network (CAN) communication, understands driver's intention, and then drives the motor. Then, the gear is operated by driving of the motor, and the parking cable is pulled by the operation of the gear to provide braking force to vehicle wheels, thereby maintaining a stable state of the vehicle. Here, tension of the parking cable is sensed by the force sensor, and is automatically set based on vehicle conditions and a vehicle gradient, thereby enabling proper braking force to be provided to the vehicle wheels.

The force sensor to sense tension of the parking cable has a large size and a complicated structure and is expensive, and thus the size of the electronic parking brake (EPB) system is also increased and manufacturing costs of the electronic parking brake (EPB) system rise.

### SUMMARY

Therefore, it is an aspect of the present invention to provide an electronic parking brake system which controls braking force according to current of a motor to achieve reduction of a product size and curtailment of manufacturing costs, and a control method thereof.

Additional aspects of the invention will be set forth in part in the description which follows and, in part, will be obvious from the description, or may be learned by practice of the invention.

In accordance with one aspect of the present invention, an electronic parking brake system includes brakes, a parking cable to apply braking force to the brakes, a motor to apply tension to the parking cable, a current sensor to sense current of the motor, and an electronic control unit to judge the braking force of the brakes based on the current of the motor, and to control driving of the motor based on the braking force.

The electronic control unit may calculate the tension applied to the parking cable based on the current of the motor, and judge the braking force of the brakes corresponding to the calculated tension.

The electronic parking brake system may further include a hall sensor to count the number of rotations of the motor, and the electronic control unit may compensate for the calculated tension by applying the number of rotations of the motor to the calculated tension.

The electronic parking brake system may further include a storage unit in which operation stroke data of the parking cable corresponding to the number of rotations of the motor is stored in advance.

In accordance with another aspect of the present invention, a control method of an electronic parking brake system includes detecting current of a motor during operation of brakes, judging braking force of the brakes based on the current of the motor, and controlling driving of the motor corresponding to the braking force.

The judgment of the braking force of the brakes may include detecting the number of rotations of the motor, judging tension of a parking cable connected to the brakes based on the current and the number of rotations of the motor, and judging the braking force corresponding to the tension of the parking cable.

### BRIEF DESCRIPTION OF THE DRAWINGS

These and/or other aspects of the invention will become apparent and more readily appreciated from the following description of the embodiments, taken in conjunction with the accompanying drawings of which:

FIG. 1 is an exemplary view of an electronic parking brake apparatus in accordance with one embodiment of the present invention;

FIG. 2 is a block diagram of an electronic parking brake system in accordance with the embodiment of the present invention; and

FIG. 3 is a flow chart illustrating a control method of the electronic parking brake system in accordance with the embodiment of the present invention.

### DETAILED DESCRIPTION

Reference will now be made in detail to the embodiments of the present invention, examples of which are illustrated in the accompanying drawings, wherein like reference numerals refer to like elements throughout.

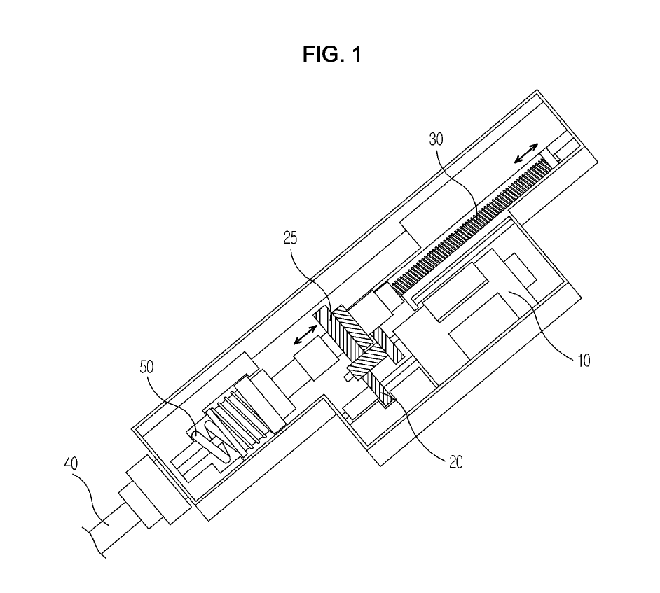

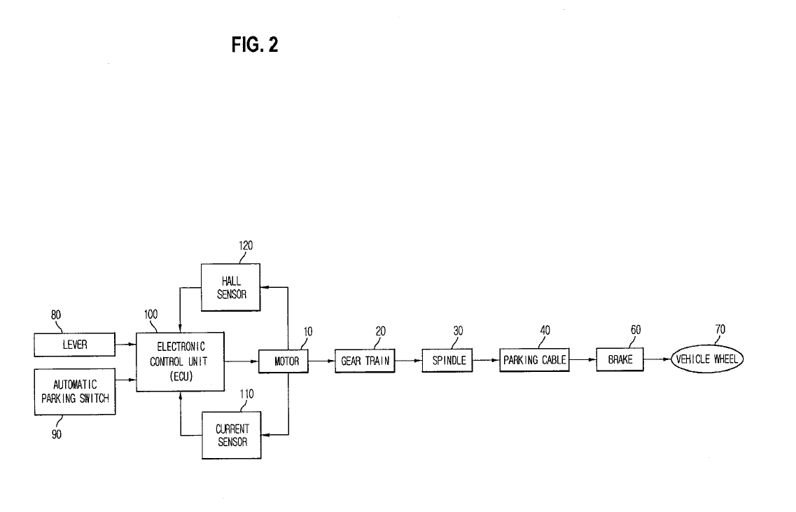

FIG. 1 is an exemplary view of an electronic parking brake apparatus in accordance with one embodiment of the present invention, and FIG. 2 is a block diagram of an electronic parking brake system to control the electronic parking brake of FIG. 1.

The electronic parking brake apparatus, as shown in FIG. 1, is a cable puller type electronic parking brake apparatus, and includes a motor 10, a gear train 20, a nut member 25, a spindle 30, a parking cable 40, and an elastic member 50. The electronic parking brake system includes the electronic parking brake apparatus, brakes 60, vehicle wheels 70, a lever 80, an automatic parking switch 90, an electronic control unit (ECU) 100, a current sensor 110, and a hall sensor 120.

The motor 10 is rotated in a regular direction or the reverse direction through power supplied from a battery (not shown) during operation of the lever 80 or the automatic parking switch 90, and provides braking force to the brakes 60 or releases the braking force from the brakes 60, thereby operating the brakes 60 or stopping the operation of the brakes 60.

The gear train 20 is driven by rotation of the motor 10 and includes a plurality of gears engaged with each other by helical gear teeth formed on the outer circumferential surfaces thereof and rotated, thereby rectilinearly reciprocating the spindle 30. The gear train 20 is provided with the nut member 25, which is screw-connected with the spindle 30 and moves in the opposite direction to the moving direction of the spindle 30.

The spindle 30 is provided with a screw formed on the outer circumferential surface thereof, and the screw is screw-connected with the nut member 25 of the gear train 20. Thereby, as the gear train 20 is driven, the spindle 30 is rotated in the nut member 25 and moves rectilinearly. The parking cable 40 is connected to the tip of the spindle 30, and thus the parking cable 40 is pulled or loosened according to the rectilinear movement of the spindle 30. When the spindle 30 moves, repulsive force corresponding to moving force of the spindle 30 is applied to the nut member 25 of the gear train 20.

The parking cable 40 is connected to the tip of the spindle 30, and is pulled or loosened according to movement of the spindle 30, thereby providing braking force to the brakes 60.

The elastic member 50 is compressed based on movement of the nut member 25 of the gear train 20. That is, the elastic member 50 is compressed based on tension applied to the parking cable 40 according to movement of the spindle 30 corresponding to movement of the nut member 25.

The brakes 60 are respectively installed at left and right rear vehicle wheels 70, and are connected to the spindle 30 through the parking cable 40. When tension of the parking cable 40 corresponding to rectilinear movement of the spindle 30 is transmitted to the brakes 60, the brakes 60 supply braking force to the vehicle wheels 70 or release the braking force from the vehicle wheels 70.

The lever 80 is used to allow a user to operate a driving mode (D), a neutral mode (N), a reverse mode (R), a sequential mode (S), or a parking mode (P). In this embodiment, operation of the lever 80 in the parking mode (P) of the vehicle will be described. The lever 80 is operated by the user in order to convert the parking mode into a parking release mode (i.e. the driving or neutral mode) or to convert the parking release mode into the parking mode, and transmits an operation signal to the electronic control unit (ECU) 100.

The automatic parking switch 90 transmits an automatic parking mode set signal to the electronic control unit (ECU) 100, when the automatic parking switch 90 is turned on by the user. That is, the automatic parking switch 90 is configured such that, when the automatic parking switch 90 is turned on by the user, conversion between the parking mode and the parking release mode of the vehicle is automatically achieved according to a change in the state of the vehicle.

The electronic control unit (ECU) 100 judges whether or not a mode change from the parking mode into the parking release mode or from the parking release mode into the parking mode is carried out by analyzing the mode signal transmitted from the lever 80, and controls operation of the brakes 60 based on a result of the judgment.

When the automatic parking mode set signal is input from the automatic parking switch 90 to the electronic control unit (ECU) 100, the electronic control unit (ECU) 100 sets an automatic parking mode, judges whether or not the mode change from the parking mode into the parking release mode or from the parking release mode into the parking mode is carried out by analyzing a state of the vehicle based on data transmitted from various sensors (not shown) or various electronic control units (not shown) of the system, and controls operation of the electronic control unit (ECU) 100 if it is judged that the mode change from the parking mode into the parking release mode or from the parking release mode into the parking mode is carried. Further, the electronic control unit (ECU) 100 controls rotation of the motor 10 so as to operate the brakes 60 or to stop the operation of the brakes 60. Thereby, the parking mode or the parking release mode of the vehicle is performed.

The electronic control unit (ECU) 100 calculates tension of the parking cable 40 based on current flowing in the motor 10 when the parking mode or the parking release mode is performed, obtains operation stroke data of the parking cable 40 corresponding to the number of rotations of the motor 10, compensates for the calculated tension of the parking cable 40 using the operation stroke data, predicts braking force of the brakes 60 based on the tension of the parking cable 40, and controls rotation of the motor 10 based on the predicted braking force, thereby controlling the tension of the parking cable 40 and the braking force of the brakes 60.

The current sensor 110 senses current flowing in the motor 10 when the motor 10 is rotated in a regular direction or the reverse direction, and transmits the current to the electronic control unit (ECU) 100, and the hall sensor 120 counts the number of rotations of the motor 10 when the motor 10 is rotated in the regular direction or the reverse direction, and transmits the number of rotations to the electronic control unit (ECU) 100.

Here, force repulsive to moving force of the spindle 30 pulling the parking cable 40 when the motor 10 is rotated is applied to the nut member 25 and thus the nut member 25 moves, and the elastic member 50 is compressed by moving force of the nut member 25. That is, the nut member 25 moves due to the rotation of the motor 10 while compressing the elastic member 50, and the moving force of the nut member 25 corresponds to rotating force of the motor 10. Accordingly, tension of the parking cable 40 may be calculated based on current of the motor 10 corresponding to the rotating force of the motor 10.

Further, pulled distance data of the parking cable 40 corresponding to the number of rotations of the motor 10, i.e. the operation stroke data, may be calculated. Such operation stroke data corresponding to the number of rotations of the motor 10 is calculated by experimentation, and is stored in advance.

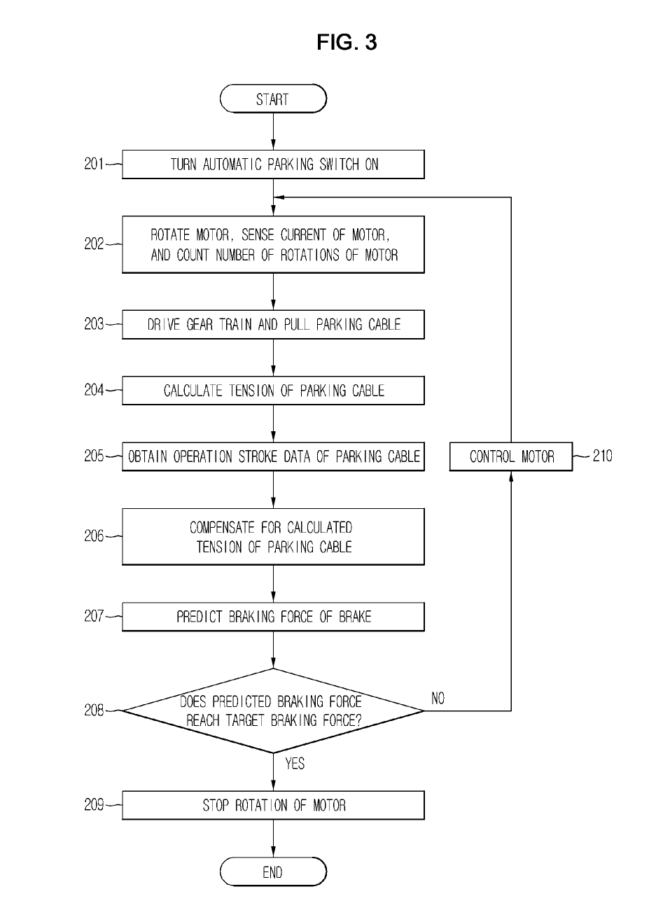

FIG. 3 is a flow chart illustrating a control method of the electronic parking brake system in accordance with the embodiment of the present invention. Hereinafter, the control method of the electronic parking brake system will be described with reference to FIGS. 1 to 3.

In this embodiment, the cable puller type electronic parking brake apparatus is described. When the automatic parking mode is performed by turning on the automatic parking switch 90, the motor 10 is rotated if automatic parking needs to be performed.

Thereafter, rotating force of the motor 10 is converted into rectilinear movement of the spindle 30 by the gear train 20, and the parking cable 40 fixed to the tip of the spindle 30 is pulled by the movement of the spindle 30. When tension higher than target tension is applied to the parking cable 40, the brakes 60 provided on the vehicle wheels 70 are operated, thereby maintaining the vehicle in a stable posture.

In order to provide proper braking force to the brakes 60 during the operation of the brakes 60, rotating force of the motor 10 needs to be correctly controlled. For this purpose, tension applied to the parking cable 40 needs to be sensed. The sensing of the tension applied to the parking cable 40 is carried out by the current sensor 110 to sense current of the motor 10. This will be described below in more detail.

If it is judged that the parking mode is performed after the automatic parking switch 90 is turned on (operation 201), the motor 10 is rotated. During the rotation of the motor 10, current flowing in the motor 10 is sensed and the number of rotations of the motor 10 is counted (operation 202).

The spindle 30 is rotated and moved by the rotation of the motor 10 via the gear train 20, and the parking cable 40 connected to the tip of the spindle 30 is pulled according to the movement of the spindle 30 (operation 203). Here, tension is applied to the parking cable 40.

Moving force in a direction opposite to the moving direction of the spindle 30 is applied to the nut member 25 of the gear train 20 screw-connected to the spindle 30, and the elastic member 50 is compressed by the moving force of the nut member 25 of the gear train 20. That is, force repulsive to the moving force of the spindle 30 pulling the parking cable 40 is applied to the nut member 25 of the gear train 20. Thereby, the tension of the parking cable 40 may be calculated by sensing the current of the motor 10 transmitting the rotating force to the gear train 20 in order to move the nut member 25 of the gear train 20.

That is, tension of the parking cable 40 corresponding to the current of the motor 10 during the movement of the spindle 30 and the nut member 25 is calculated (operation 204).

Thereafter, operation stroke data of the parking cable 40 corresponding to the number of rotations of the motor 10 is obtained (operation 205). Here, the operation stroke data of the parking cable 40 corresponding to the number of rotations of the motor 10 is stored in advance.

Thereafter, the calculated tension of the parking cable 40 is compensated by applying the operation stroke data of the parking cable 40 to the calculated tension of the parking cable 40 (operation 206), and braking force of the brakes 60 corresponding to the compensated tension of the parking cable 40 is predicted (operation 207).

Thereafter, the predicted braking force of the brakes 60 is compared with target braking force (operation 208). If the predicted braking force of the brakes 60 is greater than the target braking force, the rotation of the motor 10 is stopped (operation 209), and if the predicted braking force of the brakes 60 is smaller than the target braking force, the rotation of the motor 10 is re-controlled such that the predicted braking force of the brakes 60 reaches the target braking force (operation 210).

As described above, tension of the parking cable 40 according to current of the motor 10 is calculated, and a control signal to control rotation of the motor 10 according to the calculated tension of the parking cable 40 is generated, thereby correctly controlling braking force of the brakes 60.

Here, the current sensor 110 is a small and inexpensive sensor to sense tension of the parking cable 40, is easy to obtain a space in which the current sensor 110 is installed, reduces a product size of the electronic parking brake system, reduces manufacturing costs of the electronic parking brake system, and further reduces costs of an electronic parking brake system product and a vehicle provided with the same, thereby being economical to customers. Thus, vehicles to which the electronic parking brake system is applied may be popularized, thereby improving driver's convenience.

As is apparent from the above description, an electronic parking brake system in accordance with one embodiment of the present invention senses tension of a parking cable using a small-sized current sensor, thereby easily obtaining a space in which the current sensor is installed and thus reducing a product size of the electronic parking brake system.

Further, the electronic parking brake system in accordance with the embodiment of the present invention senses the tension of the parking cable using the inexpensive current sensor, thereby reducing manufacturing costs of the electronic parking brake system and reducing costs of an electronic parking brake system product and a vehicle provided with the same, and thus being economical to customers. Accordingly, vehicles to which the electronic parking brake system is applied may be popularized, thereby improving driver's convenience.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. An electronic parking brake system comprising:
brakes;
a parking cable to apply braking force to the brakes;
a motor to apply tension to the parking cable;
a current sensor to sense current of the motor; and
an electronic control unit to judge the braking force of the brakes based on the current of the motor, and to control driving of the motor based on the braking force.

2. The electronic parking brake system according to claim 1, wherein the electronic control unit calculates the tension applied to the parking cable based on the current of the motor, and judges the braking force of the brakes corresponding to the calculated tension.

3. The electronic parking brake system according to claim 2, further comprising a hall sensor to count the number of rotations of the motor,
wherein the electronic control unit compensates for the calculated tension by applying the number of rotations of the motor to the calculated tension.

4. The electronic parking brake system according to claim 3, further comprising a storage unit in which operation stroke data of the parking cable corresponding to the number of rotations of the motor is stored in advance.

5. A control method of an electronic parking brake system comprising:
detecting current of a motor during operation of brakes;
judging braking force of the brakes based on the current of the motor; and
controlling driving of the motor corresponding to the braking force.

6. The control method according to claim 5, wherein the judgment of the braking force of the brakes includes:
detecting the number of rotations of the motor;
judging tension of a parking cable connected to the brakes based on the current and the number of rotations of the motor; and
judging the braking force corresponding to the tension of the parking cable.
